(19) United States
(12) Patent Application Publication
(10) Pub. No.: US 2026/0166738 A1
(43) Pub. Date: Jun. 18, 2026

(54) METHOD FOR TRAINING ROBOT ACTION GENERATION MODEL AND METHOD FOR GENERATING ROBOT ACTIONS

(71) Applicant: TONGJI UNIVERSITY, Shanghai (CN)

(72) Inventors: Bin HE, Shanghai (CN); Zhongpan ZHU, Shanghai (CN); Yanmin ZHOU, Shanghai (CN); Rongfeng ZHAO, Shanghai (CN); Zhipeng WANG, Shanghai (CN); Shuo JIANG, Shanghai (CN)

(73) Assignee: TONGJI UNIVERSITY, Shanghai (CN)

(21) Appl. No.: 19/393,670

(22) Filed: Nov. 19, 2025

(30) Foreign Application Priority Data
Dec. 18, 2024 (CN) 2024118717953

(51) Int. Cl. B25J 9/16; G06F 40/284

(52) U.S. Cl. CPC B25J 9/1671; B25J 9/161; G06F 40/284

(57) ABSTRACT

A method for training a robot action generation model and a method for generating robot actions. The training method includes: constructing an automotive wire harness operation dataset and extracting human poses; constructing an instruction set based on the dataset and the human poses; pre-training a motion tokenizer; obtaining a text-motion vocabulary; pre-training a language model based on the dataset, the instruction set, and the text-motion vocabulary; and constructing an operation dataset and fine-tuning the pre-trained language model based on the operation dataset to complete training. The method for generating robot actions utilizes the robot action generation model trained by the training method to output a humanoid action sequence and redirects the humanoid action sequence to a robot to generate robot actions. The present disclosure enhances generalizability of the generation model, makes the generation of robot actions more aligned with automotive wire harness operations.

### FIELD OF TECHNOLOGY

The present disclosure relates to a technical field of humanoid robots, and in particular to a method for training a robot action generation model and a method for generating robot actions.

### BACKGROUND

Currently, wire harnesses are critical components in modern vehicles, particularly electric vehicles, as they facilitate the transmission of power and signals to enable essential functions. With the rapid development of smart vehicles, the number of wire harnesses required for components such as vehicle doors, engines, and entire vehicle bodies has grown exponentially. However, the assembly of automotive wire harnesses presently relies heavily on manual labor, imposing significant pressure on both operators and manufacturing facilities. A prominent solution to this challenge involves leveraging robotic automation to reduce manual labor demands and enhance productivity. The deformable nature of automotive wire harnesses necessitates robots with dexterity and intelligence, making the realization of intelligent and dexterous robotic assembly of wire harnesses a critical objective.

Generative approaches have demonstrated significant achievements in the field of robotic skill learning, with proven effectiveness in improving robotic operations across various physical robotic arms. Chinese patent application CN106600000A discloses a method for mapping human-robot motion data, wherein human motion data serves as input to a deep learning model, and robot sample data serves as the desired output of the model. Although this method achieves a mapping relationship between human and robot motion data, it does not incorporate textual information to guide robot action generation, rendering it unsuitable for automotive wire harness assembly and limited in generalizability.

Accordingly, there exists a need to provide a method for generating robot actions that is applicable to automotive wire harness assembly and possesses robust generalizability.

### SUMMARY

The present disclosure addresses the shortcomings of the prior art by providing a method for training a robot action generation model and a method for generating robot actions, which, based on language-action understanding, constructs prompt data using human poses, thereby effectively enhancing the accuracy of robot action generation.

According to a first aspect of the present disclosure, the method for training a robot action generation model is provided, wherein the robot action generation model includes a motion tokenizer, a language model module, and a SentencePiece module, and the method includes:
Constructing an automotive wire harness operation dataset, including a motion dataset and a text dataset of workers operating wire harnesses, and extracting human poses based on the motion dataset;
Constructing an instruction set based on the text dataset, the motion dataset, and the human poses, wherein data types of the instruction set include a functional description of the language model, functional labels, functional categories, inputs, and outputs;
Obtaining a text vocabulary from the language model module, pre-training the motion tokenizer based on the text vocabulary and the motion dataset, and generating a text vocabulary containing motion semantics and a motion vocabulary;
Integrating the text vocabulary, the text vocabulary containing motion semantics, and the motion vocabulary using the SentencePiece module to obtain a text-motion vocabulary;
Pre-training a language model based on the automotive wire harness operation dataset, the instruction set, and the text-motion vocabulary; and
Constructing an operation dataset, fine-tuning the pre-trained language model based on the operation dataset to complete training, wherein data types of the operation dataset include human automotive wire harness wiring, wire harness terminal insertion, and wire harness wrapping operation data.

As a preferred technical solution, the human poses are three-dimensional data.

As a preferred technical solution, the pre-training method for the motion tokenizer includes:
randomly selecting multiple action sequences from the motion dataset as a training set;
representing the action sequences as

$${m}^{1 : F} = {\{ {x}^{i} \}}_{i = 1}^{F} ,$$

wherein F represents an action sequence of F frames, i represents an i-th action sequence, and x represents an action;
discretizing the action sequences into action discrete tokens

$${t}^{1 : f} = {\{ {t}^{i} \}}_{i = 1}^{f}$$

of a preset length, wherein t represents a single data point in the discrete tokens, i represents an i-th data point in the discrete tokens, f represents the preset length f=F/l, and l represents a sampling time.
decoding the action discrete tokens into action sequences \hat{m}^{1:F}=D(E(m^{1:F})), and calculating a loss based on decoded action sequences \hat{m}^{1:F} and the action sequences m^{1:F}; and
optimizing the motion tokenizer based on the loss.

As a preferred technical solution, generating the motion vocabulary includes: discretizing each action sequence in the motion dataset into action discrete tokens using the pre-trained motion tokenizer, and integrating all the action discrete tokens to obtain the motion vocabulary.

As a preferred technical solution, obtaining the text vocabulary containing motion semantics includes: randomly providing a language text description containing temporal information to the motion tokenizer, and iteratively performing text-action matching based on the text vocabulary and the motion vocabulary until text sequences in the text vocabulary and action sequences in a motion codebook maintain temporal sequence consistency.

As a preferred technical solution, obtaining the text-motion vocabulary includes:
obtaining all text discrete tokens from the text vocabulary and the text vocabulary containing motion semantics;
encoding all the text discrete tokens into basic units; and
obtaining all action discrete tokens from the motion vocabulary, and inputting action discrete tokens and the basic units into the SentencePiece module for integration in temporal order.

As a preferred technical solution, pre-training the language model includes calculating a pre-training loss using a log-likelihood given by:

$$L = {\sum }_{i = 0}^{{L}_{t} - 1} log p ( {x}_{t}^{i} \vert {x}_{t}^{< i} , x )$$

wherein

$${x}_{t}^{i}$$

represents an i-th discrete token in the action sequence at time t,

$${x}_{t}^{< i}$$

represents the preceding i discrete tokens in the action sequence at time t, Lₜ represents a represents the length of a current action sequence, and

$$p ( {x}_{t}^{i} \vert {x}_{t}^{< i} , x )$$

represents a probability at time t.

According to a second aspect of the present disclosure, a method for generating robot actions is provided, the method includes generating robot action using a robot action generation model trained by the method described above, the method including:
obtaining an instruction for operating a wire harness and inputting the instruction into the motion tokenizer to output discrete action tokens;
inputting the discrete action tokens into the language model module to output a 3D humanoid action sequence; and
generating robot actions based on the 3D humanoid action sequence using a redirection method.

As a preferred technical solution, generating the robot actions includes:
defining a target function as a distance between a position of a current joint end effector of a robot and a target position given by:

$$F ( θ ) = {‖ {p}_{target} - p ( θ ) ‖}^{2}$$

wherein p_{target} represents the target position, and p(θ) represents the position of the end effector at a current joint angle;
obtaining a position of each end effector based on the target function; and
integrating the position of each end effector to generate the robot actions.

As a preferred technical solution, obtaining a position of each end effector based on the target function includes: using a gradient descent method to find the position of the end effector that minimizes the target function.

Compared with the prior art, the present disclosure offers the following advantages:
1) During the training process of the robot action generation model, the present disclosure utilizes human poses as prompt data for the language model, integrating instructions encompassing text-to-text, text-to-action, and action-to-action aspects in the process of generating robot actions to construct the instruction set. By training the robot action generation model based on the instruction set and human poses, the model generates actions more suitable for automotive wire harness operations while understanding action description syntax. Furthermore, the model training method provided by the present disclosure ensures that the robot action generation model effectively learns and generalizes to a variety of automotive wire harness-related tasks.
2) In the robot action generation process, the present disclosure maps actions generated by the robot action generation model to a humanoid robot through a redirection approach, thereby not only enhancing the accuracy of robot action generation but also producing a broader range of automotive wire harness operation actions and improving the flexibility of robotic operations on wire harnesses.
3) The robot action generation model provided by the present disclosure, when generating robot actions, does not require online matching or training for given task text instructions, effectively saving time and improving operational efficiency

### BRIEF DESCRIPTION OF THE DRAWINGS

FIG. 1 shows an overall flowchart of a method for training a robot action generation model and a method for generating robot actions of the present disclosure.

FIG. 2 shows a schematic diagram of training a robot action generation model of the present disclosure.

FIG. 3 shows a framework diagram of an action generation of the present disclosure.

### DETAILED DESCRIPTION

The technical solutions in the embodiments of the present disclosure will be described clearly and completely below with reference to the accompanying drawings in the embodiments of the present disclosure. It is apparent that the described embodiments are only a portion of the embodiments of the present disclosure, rather than all embodiments. Based on the embodiments in the present disclosure, all other embodiments obtained by those of ordinary skill in the art without making creative efforts shall fall within the scope of the present disclosure.

The drawings described below are merely some examples or embodiments of the present application. For those of ordinary skill in the art, without exerting creative efforts, the present disclosure can also be applied to other similar scenarios based on these drawings. Furthermore, it is understood that, although the efforts made during this development process may be complex and protracted, for those of ordinary skill in the art related to the content disclosed in the present disclosure, certain changes in design, manufacturing, or production based on the technical content disclosed in the present application are merely conventional technical means and should not be construed as insufficient disclosure of the present disclosure.

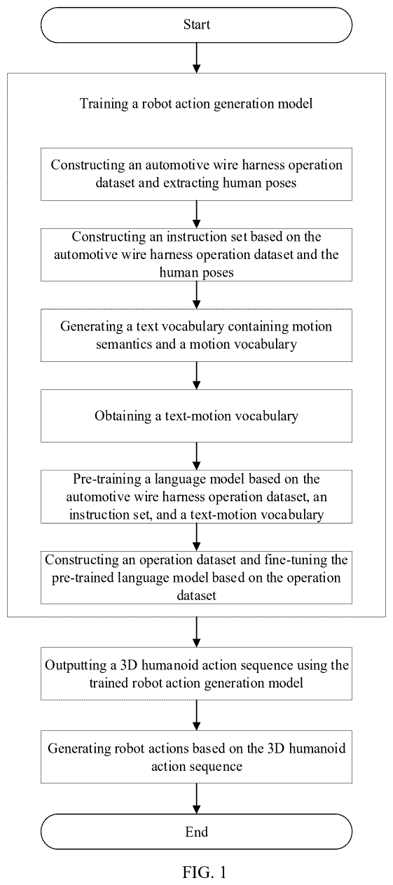

The present disclosure relates to a method for training a humanoid robot action generation model for dexterous automotive wire harness operations and a method for generating humanoid robot actions. To address the high labor demand for operational tasks in automotive wire harness production lines, the present disclosure constructs a humanoid robot action generation model using text-to-action techniques, utilizing human pose data as prompt data to improve the actions generated by the model. The detailed process of the present disclosure is illustrated in FIG. 1, including two main modules: model training and action generation.

### Embodiment 1

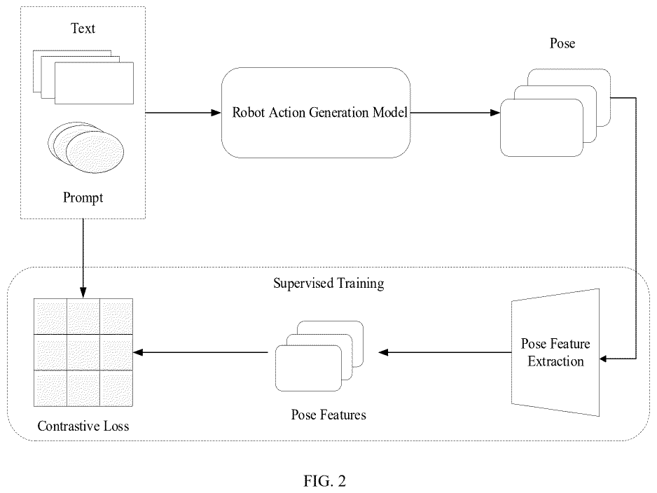

This embodiment provides a method for training a robot action generation model, wherein the method includes using human pose data from automotive wire harness operations as prompt data for the robot action generation model. The robot action generation model includes a motion tokenizer, a Llama language model module, and a SentencePiece module. An instruction set is constructed by integrating text data and motion data from the automotive wire harness process. The robot action generation model is pre-trained based on the instruction set, human pose data, motion data, and text data, eliminating the need for online matching and training for specific text, thereby saving model training time and improving training efficiency. The framework of the method is illustrated in FIG. 2, including steps S1-S6:

S1. Arranging an automotive wire harness operation scenario and collecting a motion dataset and a text dataset from workers operating wire harnesses, wherein the motion dataset and the text dataset are collectively referred to as a wire harnesses operation dataset. Human poses are extracted from the motion dataset as prompt data for the subsequent robot action generation model, wherein the human pose data is in a three-dimensional spatial format.

The motion data and text data may be acquired by one or more of motion capture cameras, RGB cameras, and IMU sensors, and the collected data types include at least: joint coordinates in three-dimensional directions, pitch-roll-yaw angles of joints, angular acceleration, and a complete operation video of an operational task.

S2. Constructing an instruction set:

Constructing the instruction set based on the text dataset, the motion dataset, and human poses, and stored in a json file format, wherein the data types of the instruction set include functional descriptions of the Llama language model containing text language descriptions with various motion semantics, functional labels such as “text-to-pose,” “text-to-motion,” and “text-to-text,” functional categories such as “t2p,” “t2m,” and “t2t,” and inputs and outputs. The construction of the instruction set including text-to-text, text-to-action, and action-to-action instructions is implemented to assist the Llama language model in better understanding text and generating corresponding humanoid action sequences.

During the pre-training process of the Llama language model, the instruction set defines input-output templates for different tasks, providing the Llama language model with clear task structure and data format guidance. The model parses and processes different types of task data based on the content in the file, populating actual data into placeholders, learning patterns and features of different tasks, and learning how to map inputs to desired outputs. Thus, the instruction set primarily serves to define task structures and standardize data formats, ensuring that the Llama language model effectively learns and generalizes to various motion-related tasks.

Specifically, the code for constructing the instruction set is shown in Table 1.

TABLE 1
Instruction Set Construction Code

```
// instruction
{“text-to-pose”: {“caption”: {“class”: “t2p”, “input”: [“Create a pose that communicates the essence of Input:
<Caption_Placeholder>”,
      “Generate a gesture that encapsulates the spirit of Input: <Mood_Placeholder>”,
      “Craft a stance that embodies the sentiment of Input: <Emotion_Placeholder>”,
      “Design a posture that reflects the atmosphere of Input: <Theme_Placeholder>”,
      ...],”output”: [“<pose_Placeholder>”]},
  “caption_framelen”: {“class”: “t2p”,”input”: [“Give me a pose that lasts for approximately <Frame_Placeholder> frames. The
caption is: <Caption_Placeholder>”,
      “Provide a stance that endures for roughly <Frame_Placeholder> frames. The description is:
<Caption_Placeholder>”,
      “Show me a gesture that spans about <Frame_Placeholder> frames. The title is: <Caption_Placeholder>”,
      ...],”output”: [“<pose_Placeholder>”]},
  “caption_seclen”: {“class”: “t2p”,”input”: [“Generate a pose that is around <Second_Placeholder> seconds long for the
caption: Input: <Caption_Placeholder>”,
      “Develop a posture that lasts for approximately <Second_Placeholder> seconds to match the caption: Input:
<Caption_Placeholder>”,
      “Create a stance that endures for about <Second_Placeholder> seconds corresponding to the caption: Input:
<Caption_Placeholder>”,
      “Formulate a gesture that spans for roughly <Second_Placeholder> seconds to fit the caption: Input:
<Caption_Placeholder>”,
      ...],”output”: [“<pose_Placeholder>”]},
  “framelen”: {“class”: “l2p”,”input”: [“I want to see a pose that lasts between <Frame_Placeholder> and
<Frame_Placeholder> frames”,
      “I'd like to observe a stance that spans from <Frame_Placeholder> to <Frame_Placeholder> frames.”,
      “Please display a gesture that endures between <Frame_Placeholder> and <Frame_Placeholder> frames.”,
      ...],”output”: [“<pose_Placeholder>”]},
  “seclen”: {“class”: “l2p”,”input”: [“I want to see a pose that lasts between <Second_Placeholder> and
<Second_Placeholder> seconds”,
      “I would like to view a stance that endures from <Second_Placeholder> to <Second_Placeholder> seconds.”,
      “Please present a movement that spans the duration of <Second_Placeholder> to <Second_Placeholder> seconds.”,
      ...],”output”: [“<pose_Placeholder>”]},
  “random”: {“class”: “r2p”,”input”: [“Generate random movements without any indication.”,
      “Create spontaneous gestures without any prior notice.”,
      “Produce unprompted motions at random intervals.”,
      “Initiate unexpected actions without any signals.”,
      ...],”output”: [“<pose_Placeholder>”]}},
  “text-to-motion”: {“caption”: {“class”: “t2m”,”input”: [“Create a motion that communicates the essence of Input:
<Caption_Placeholder>”,
      “Create a motion that embodies the spirit of Input: <Caption_Placeholder>”,”Generate a movement sequence that
reflects Input: <Caption_Placeholder>”, ...],”output”: [“<motion_Placeholder>”]},
  “caption_framelen”: {“class”: “t2m”,”input”: [“Give me a motion that lasts for approximately <Frame_Placeholder> frames.
The caption is: <Caption_Placeholder>”,
      “Generate a motion sequence lasting around <Frame_Placeholder> frames. The caption is: <Caption_Placeholder>”,
      “Create a motion of approximately <Frame_Placeholder> frames with the caption: <Caption_Placeholder>”,
      “Provide a movement that spans about ‘<Frame_Placeholder>‘ frames. Caption: <Caption_Placeholder>”,
      ...],”output”: [“<motion_Placeholder>”]},
  “caption_seclen”: {“class”: “t2m”,”input”: [“Generate a motion that is around <Second_Placeholder> seconds long for the
caption: Input: <Caption_Placeholder>”,
      “Create a motion sequence approximately <Second_Placeholder> seconds long for the caption: Input:
<Caption_Placeholder”,
      “Produce a motion lasting around <Second_Placeholder> seconds with the caption: Input: <Caption_Placeholder>”,
      “Design a motion clip of roughly <Second_Placeholder> seconds, based on the caption: Input:
<Caption_Placeholder>”,
      ...],”output”: [“<motion_Placeholder>”]},
  “framelen”: {“class”: “l2p”,”input”: [“I want to see a motion that lasts between <Frame_Placeholder> and
<Frame_Placeholder> frames”,
      “Generate a motion sequence that spans between ‘<Frame_Placeholder>‘ and ‘<Frame_Placeholder>‘ frames”,
      “Create an animation lasting from ‘<Frame_Placeholder>‘ to ‘<Frame_Placeholder>‘ frames in duration”,
      “Design a motion that unfolds over a period of ‘<Frame_Placeholder>‘ to ‘<Frame_Placeholder>‘ frames”,
      ...],”output”: [“<motion_Placeholder>”] },
  “seclen”: {“class”: “l2m”,”input”: [“I want to see a motion that lasts between <Second_Placeholder> and
<Second_Placeholder> seconds”],”output”: [“<motion_Placeholder>”]},
  “random”: {“class”: “r2m”,”input”: [“Generate random movements without any indication.”],”output”:
[“<motion_Placeholder>” ]}},
  “Text-to-Text”: {“caption-to-framelen”: {“class”: “t2t”,”input”: [“Predict the frame count required for the motion corresponding
to <Caption_Placeholder>.”,
      “What is the anticipated frame count for the motion described by <Caption_Placeholder>?”,
      “What is the expected duration of the motion that matches <Caption_Placeholder> in terms of frame count?”,
      “Estimate the number of frames needed to execute the movement associated with <Caption_Placeholder>.”,
      “Determine the frame count necessary for the action that corresponds to <Caption_Placeholder>.”,
      ...],”output”: [“The motion has an estimated duration of <Frame_Placeholder> frames.”,
      “The motion has a length of <Frame_Placeholder> frames.”,
      “The motion has an estimated duration of around <Frame_Placeholder> frames.”,...]},
  “caption-to-seclen”: {“class”: “t2t”,”input”: [“Estimate the expected number of seconds required for the motion that matches
<Caption_Placeholder>.”,
      “What is the expected second length for the motion that corresponds to <Caption_Placeholder>?”,
      “Estimate the second duration required for the motion that corresponds to <Caption_Placeholder>.”,
      ...],”output”: [“The motion has a duration of about <Second_Placeholder> seconds.”,
      “The length of the motion is <Second_Placeholder> seconds.”,...]},
  “framelen-to-caption”: {“class”: “t2t”,”input”: [“Based on the <Frame_Placeholder> frames of the motion, what is the
likelihood of it being a full-body movement or a partial-body movement?”,
      “Given <Frame_Placeholder> frames of motion, predict the likelihood of it being a unilateral or bilateral movement.”,
      “Given the <Frame_Placeholder> frames of the motion, what are some possible actions that could be
taken?”,...],”output”: [“<Caption_Placeholder>”]},
  “seclen-to-caption”: {“class”: “t2t”,”input”: [“Based on the duration <Second_Placeholder> seconds of the motion, what is
the likelihood of it being a full-body movement or a partial-body movement?”,
      “Given the duration <Second_Placeholder> seconds of the motion, what are some possible actions that could be
taken?”,
      “What are some possible scenarios where <Second_Placeholder> seconds of motion would be required?”,
      “Given <Second_Placeholder> seconds of motion, predict the likelihood of it being a concentric or eccentric
movement.”,
      “What are some possible ways to modify the motion to make it more accessible or inclusive, based on the number of
<Second_Placeholder> seconds?”,
      ...],”output”: [“<Caption_Placeholder>”]},
  “random-caption”: {“class”: “n2t”,”input”: [“Write a brief summary of how someone might move their feet while doing the
foxtrot.”,
      “Describe the motion of someone doing a lunge.”,”Write a brief summary of how someone might move their shoulders
while dancing.”,
      “Describe the motion of someone doing a burpee.”,”Describe the way someone might move while doing a
corkscrew.”,...],”output”: [“<Caption_Placeholder>”]}}
  “Motion-to-Motion”: {“motion_prediction”: {“class”: “predict”,”input”: [“Predict motion: <Motion_Placeholder_s1>”,”Do the
motion prediction task for <Motion_Placeholder_s1>”,
      “Predict the motion sequence for: ‘<Motion_Placeholder_s1>‘”,...],”output”: [“<Motion_Placeholder_s2>”]},
  “motion_inbetween”: {“class”: “inbetween”,”input”: [“Complete the masked motion: <Motion_Placeholder_Masked>”,”Here
is a masked motion sequence <Motion_Placeholder_Masked>, complete it”
    ],”output”: [“<Motion_Placeholder>”]}},
  “Motion-to-Text”: {“caption”: {“class”: “m2t”,”input”: [“Describe the motion represented by <Motion_Placeholder> using plain
English.”,
      “Provide a text-based explanation of the action being shown in <Motion_Placeholder>.”,...],”output”:
[“<Caption_Placeholder>”]},
  “framelen”: {“class”: “m2t”,”input”: [“What is happening in <Motion_Placeholder> during a duration of
<Frame_Placeholder> frames?”,
      “Describe the motion depicted in <Motion_Placeholder> over <Frame_Placeholder> frames.”,...],”output”:
[“<Caption_Placeholder>”]},
  “seclen”: {“class”: “m2t”, “input”: [“Describe the movement being shown in <Motion_Placeholder> that is exhibited for a
duration of <Second_Placeholder> seconds.”,
      “What is happening in <Motion_Placeholder> over a length of <Second_Placeholder> seconds?”,...],”output”:
[“<Caption_Placeholder>”]},
  “count-frame”: {“class”: “m2l”,”input”: [“What is the duration of <Motion_Placeholder>'s gestures in frames?”,
      “Compute the frame count for <Motion_Placeholder>'s body movements.”,...],”output”: [“There are
<Frame_Placeholder> frames in the motion.”,
      “The length of given motion is about <Frame_Placeholder> frames.”,...]},
  “count-sec”: {“class”: “m2l”,”input”: [“How many seconds are there in <Motion_Placeholder>?”,”Calculate the second
duration for <Motion_Placeholder>'s actions.”,
      “How many seconds are in <Motion_Placeholder>'s activities?”,”Calculate the length of <Motion_Placeholder> in
seconds.”,
      ...],”output”: [ “There are about <Second_Placeholder> seconds in the motion.”,”The motion lasts for roughly
estimated <Second_Placeholder> seconds.”,...]}}
```

S3. Obtaining a text vocabulary from the language model module, pre-training the motion tokenizer based on the text vocabulary and the motion dataset. The motion tokenizer includes an action decoder D and an action encoder E, and generates the text vocabulary containing motion semantics and the motion vocabulary.

S1 specifically include:

S31. Randomly selecting multiple action sequences from the motion dataset as a training set.

S32. Representing the action sequences as

$${m}^{1 : F} = {\{ {x}^{i} \}}_{i = 1}^{F} ,$$

wherein F represents an action sequence of F frames, i represents the i-th action sequence, and x represents an action.

S33. Discretizing the action sequences into action discrete tokens

$${r}^{1 : f} = {\{ {t}^{i} \}}_{i = 1}^{f}$$

of a preset length the discrete tokens, i represents an i-th data point in the discrete tokens, f represents the preset length f=F/l, and l represents a sampling time.

S34. Decoding the action discrete tokens into action sequences \hat{m}^{1:F}=D(E(m^{1:F})), and calculating a loss based on decoded action sequences \hat{m}^{1:F} and the action sequences m^{1:F}.

S35. Optimizing the motion tokenizer based on the loss.

S4. Integrating the text vocabulary, the text vocabulary containing motion semantics, and the motion vocabulary using the SentencePiece module to obtain a text-motion vocabulary.

S41. Generating the motion vocabulary: discretizing each action sequence in the motion dataset into action discrete tokens using the pre-trained motion tokenizer, and integrating all the action discrete tokens to obtain the motion vocabulary.

S42. Obtaining the text vocabulary containing motion semantics: randomly providing a language text description containing temporal information to the motion tokenizer, and iteratively performing text-action matching based on the text vocabulary and the motion vocabulary until text sequences in the text vocabulary and action sequences in a motion codebook maintain temporal sequence consistency.

S43. Obtaining the text-motion vocabulary: obtaining all text discrete tokens from the text vocabulary and the text vocabulary containing motion semantics; encoding all the text discrete tokens into basic units; and obtaining all action discrete tokens from the motion vocabulary, and inputting action discrete tokens and the basic units into the SentencePiece module for integration in temporal order, wherein the integration process ensures that the temporal order of the text and the actions remains consistent.

S5. Pre-training the language model.

A primary purpose of action generation based on the language model is to learn the semantic coupling between actions and text. Therefore, the pre-training includes pre-training the language model based on the dataset, the instruction set, and the text-motion vocabulary obtained from steps S1-S4. To achieve better performance in generation tasks and enhance the language model's ability to understand and generate results similar to samples in the training dataset, a log-likelihood is used to measure the probability of predicting the next token. This is converted into a product form of probabilities expressed as a sum of logarithms to handle long-sequence data such as action sequences, avoiding numerical overflow caused by the exponential reduction of probability products as sequence length increases, facilitating model parameter optimization by maximizing the log-likelihood, and simplifying gradient computation. By adjusting model parameters using the computed gradients, the model's output probability distribution is aligned as closely as possible with the actual data distribution, namely the joint distribution of text-action sequences in the text-motion vocabulary, to better understand and generate text similar to the training dataset samples.

Specifically, a pre-training loss is calculated using a log-likelihood given by:

$$L = {\sum }_{i = 0}^{{L}_{t} - 1} log p ( {x}_{t}^{i} \vert {x}_{t}^{< i} , x ) .$$

wherein

$${x}_{t}^{i}$$

represents an i-th discrete token in the action sequence at time t,

$${x}_{t}^{< i}$$

represents the preceding i discrete tokens in the action sequence at time t, Lₜ represents the length of a current action sequence, and

$$p ( {x}_{t}^{i} \vert {x}_{t}^{< i} , x )$$

represents a probability at time t.

S6. Constructing an operation dataset including human automotive wire harness wiring, wire harness terminal insertion, and wire harness wrapping operation data, and fine-tuning the pre-trained language model based on this operation dataset to enhance the model's performance in related tasks, thereby completing the training.

### Embodiment 2

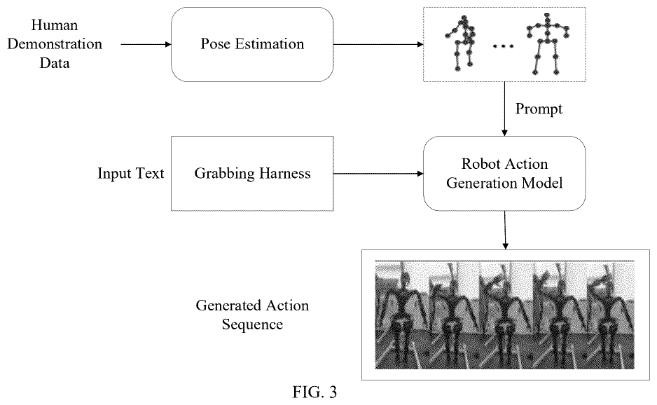

This embodiment provides a method for generating robot actions, which utilizes the robot action generation model trained by the model training method provided in the above embodiment to generate robot actions. The process, as shown in FIG. 3, includes.

A1. Obtaining an instruction for operating a wire harness and inputting the instruction into the motion tokenizer to output discrete action tokens.

A2. Inputting the discrete action tokens into the language model module to output a 3D humanoid action sequence.

A3. Generating robot actions based on the 3D humanoid action sequence using a redirection method.

A31. Defining a target function as the minimum distance between a position of a current joint end effector of a robot and a target position given by:

$$F ( θ ) = {‖ {p}_{target} - p ( θ ) ‖}^{2}$$

wherein p_{target} represents the target position, and p(θ) represents the position of the end effector at a current joint angle.

A32. Using a gradient descent method based on the target function to find the position of each end effector corresponding to the minimum value of the target function.

A33. Integrating the position of each end effector to generate the robot actions.

The above description is merely specific embodiments of the present disclosure, but the scope of the present disclosure is not limited thereto. Any person skilled in the art, within the technical scope disclosed by the present disclosure, can readily conceive of various equivalent modifications or substitutions, and such modifications or substitutions shall fall within the scope of the present disclosure. Therefore, the scope of protection of the present disclosure shall be determined by the scope of the claims.

What is claimed is:

1. A method for training a robot action generation model, wherein the robot action generation model comprises a motion tokenizer, a language model module, and a SentencePiece module, the method comprising:
constructing an automotive wire harness operation dataset comprising a motion dataset and a text dataset of workers operating wire harnesses, and extracting human poses based on the motion dataset;
constructing an instruction set based on the text dataset, the motion dataset, and the human poses, wherein data types of the instruction set comprise a functional description of the language model, functional labels, functional categories, inputs, and outputs;
obtaining a text vocabulary from the language model module, pre-training the motion tokenizer based on the text vocabulary and the motion dataset, and generating a text vocabulary containing motion semantics and a motion vocabulary;
integrating the text vocabulary, the text vocabulary containing motion semantics, and the motion vocabulary using the SentencePiece module to obtain a text-motion vocabulary;
pre-training a language model based on the automotive wire harness operation dataset, the instruction set, and the text-motion vocabulary; and
constructing an operation dataset, fine-tuning the pre-trained language model based on the operation dataset to complete training, wherein data types of the operation dataset comprise human automotive wire harness wiring, wire harness terminal insertion, and wire harness wrapping operation data.

2. The method for training the robot action generation model according to claim 1, wherein the human poses are three-dimensional data.

3. The method for training the robot action generation model according to claim 1, wherein pre-training the motion tokenizer comprises:
randomly selecting multiple action sequences from the motion dataset as a training set;
representing the action sequences as
$${m}^{1 : F} = {\{ {x}^{i} \}}_{i = 1}^{F} ,$$
wherein F represents an action sequence of F frames, i represents an i-th action sequence, and x represents an action;
discretizing the action sequences into action discrete tokens
$${t}^{1 : f} = {\{ {t}^{i} \}}_{i = 1}^{f}$$
of a preset length, wherein t represents a single data point in the discrete tokens, i represents an i-th data point in the discrete tokens, f represents the preset length f=F/l, and l represents a sampling time;
decoding the action discrete tokens into action sequences \hat{m}^{1:F}=D(E(m^{1:F})), and calculating a loss based on decoded action sequences \hat{m}^{1:F} and the action sequences m^{1:F}; and
optimizing the motion tokenizer based on the loss.

4. The method for training the robot action generation model according to claim 1, wherein generating the motion vocabulary comprises: discretizing each action sequence in the motion dataset into action discrete tokens using the pre-trained motion tokenizer, and integrating all the action discrete tokens to obtain the motion vocabulary.

5. The method for training the robot action generation model according to claim 1, wherein obtaining the text vocabulary containing motion semantics comprises: randomly providing a language text description containing temporal information to the motion tokenizer, and iteratively performing text-action matching based on the text vocabulary and the motion vocabulary until text sequences in the text vocabulary and action sequences in a motion codebook maintain temporal sequence consistency.

6. The method for training the robot action generation model according to claim 5,
wherein obtaining the text-motion vocabulary comprises:
obtaining all text discrete tokens from the text vocabulary and the text vocabulary containing motion semantics;
encoding all the text discrete tokens into basic units; and
obtaining all action discrete tokens from the motion vocabulary, and inputting action discrete tokens and the basic units into the SentencePiece module for integration in temporal order.

7. The method for training the robot action generation model according to claim 1, wherein pre-training the language model comprises calculating a pre-training loss using a log-likelihood given by:
$$L = {\sum }_{i = 0}^{{L}_{t - 1}} log p ( {x}_{t}^{i} \vert {x}_{t}^{< i} , x )$$
wherein
$${x}_{t}^{i}$$
represents an i-th discrete token in the action sequence at time t,
$${x}_{t}^{< i}$$
represents the preceding i discrete tokens in the action sequence at time t, Lₜ represents the length of a current action sequence, and
$$p ( {x}_{t}^{i} \vert {x}_{t}^{< i} , x )$$
represents a probability at time t.

8. A method for generating robot actions, wherein the method comprises generating robot actions using a robot action generation model trained by the method according to claim 1, wherein the method comprises:
obtaining an instruction for operating a wire harness and inputting the instruction into the motion tokenizer to output discrete action tokens;
inputting the discrete action tokens into the language model module to output a 3D humanoid action sequence; and
generating robot actions based on the 3D humanoid action sequence using a redirection method.

9. The method for generating robot actions according to claim 8, wherein generating the robot actions comprises:
defining a target function as a distance between a position of a current joint end effector of a robot and a target position given by:
$$F ( θ ) = {‖ {p}_{t a r g e t} - p ( θ ) ‖}^{2}$$
wherein p_{target} represents the target position, and p(θ) represents the position of the end effector at a current joint angle;
obtaining a position of each end effector based on the target function; and
integrating the position of each end effector to generate the robot actions.

10. The method for generating robot actions according to claim 9, wherein obtaining a position of each end effector based on the target function comprises: using a gradient descent method to find a position of the end effector that minimizes the target function.
